(19) United States
(12) Patent Application Publication
(10) Pub. No.: US 2004/0170884 A1
(43) Pub. Date: Sep. 2, 2004

(54) Fuel cell

(76) Inventors: Georg Frank, Laupheim (DE); Cornelius Haas, Daisendorf (DE); Werner Scherber, Bermatingen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/474,851

(22) PCT Filed: Apr. 4, 2002
(86) PCT No.: PCT/DE02/01218

(30) Foreign Application Priority Data
Apr. 14, 2001 (DE) 101-18-651.7

(51) Int. Cl. H01M 8/02; H01M 4/96; H01M 8/10

(52) U.S. Cl. 429/38; 429/30; 429/44

(57) ABSTRACT

The invention relates to a fuel cell consisting of one or more individual cells, wherein an individual cell is comprised of electrolyte-electrodes unit, means for gas distribution of reactants to the electrodes and an electric contacting of the individual cells. The inventive fuel cell has the following characteristics: the electrodes comprise electrically conductive, regularly disposed micro or nanoscale needle-shaped or tubular-shaped electrode elements affixed on a gas-permeable carrier substrate and coated with a catalyst; the electrode elements are fully or partially surrounded on the outside by the material of the electrolytes; the catalytic reaction zones in the electrode elements are connected to the means for gas distribution by the gas-permeable carrier substrate; the electrode elements are connected to one another and to the electric contacting of the individual cells in an electrically conductive manner.

The present invention relates to a fuel cell according to the definition of the species in Patent Claim 1.

The performance of a hydrogen-operated fuel cell responsible depends primarily on the oxygen reduction taking place on the cathode side and on the recombination of the hydrogen ions and oxygen ions. According to the prior art, this reaction is optimized, for example, by using a 3D reaction zone (active layer) located between the ion-conducting electrolyte (usually a prefabricated membrane such as a polymer electrolyte membrane PEM) and the GDL (gas diffusion layer). Together with the anode side, the electrolyte-electrode assembly (usually referred to as MEA, membrane electrode assembly, when using an electrolyte in the form of a membrane) represents a complex electrochemical system, whose inner structure and mode of operation not only directly determine the efficiency of the cell, but also decisively influence the design of the other components of the fuel cell stack and peripheral units, and which plays a dominant role in all considerations regarding a potential increase in performance of the fuel cell (efficiency, compact design, durability, reliability).

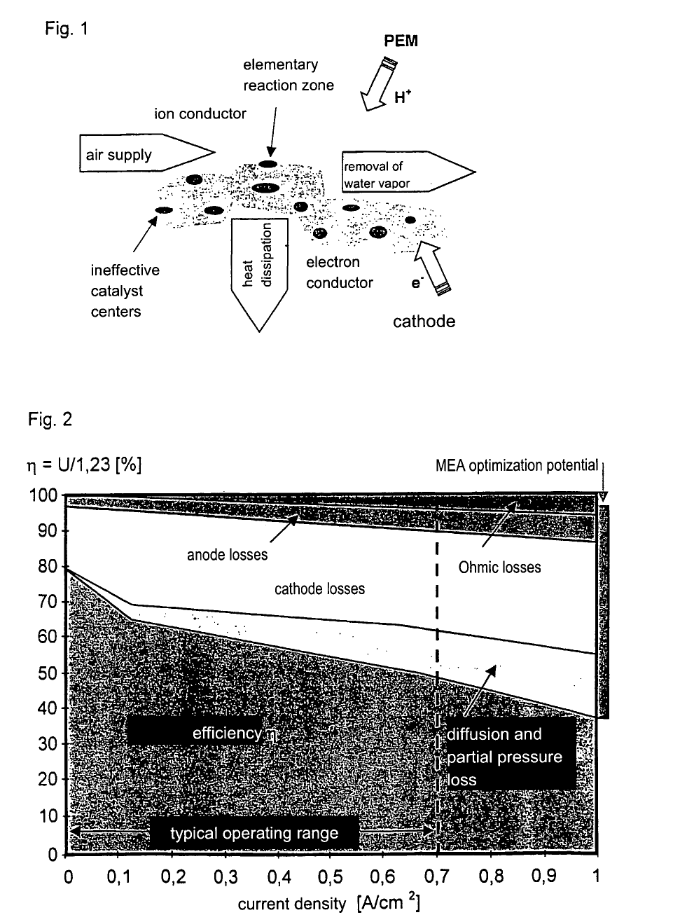

Microscopically speaking, the electrochemical reaction at the electrodes of a fuel cell always occurs only in regions where the catalyst is in direct contact with both an electron-conducting phase and an ion-conducting phase; i.e., each catalyst grain contributing to the conversion must be physically connected to the PEM on the one hand and to the external contact (bipolar plate) on the other hand. In addition, reaction gases must be able to diffuse in and out as unhindered as possible in these zones (FIG. 1). This requirements inevitably lead to highly porous micro- and nanoscale structures, but even with that, they can be met only to a limited extent, because in a three-phase system, the degree of percolation of each partner and the sum of their common boundary surfaces are conflicting parameters.

There have been proposed many ways to deal with this problem. A preferred manufacturing method for fuel cell electrodes is based on wet-chemical deposition of minute Pt particles on larger carbon particles which, together with ionomer binders, solvents and other additives, are mixed to form a paste which is then applied to carbon paper (which forms the GDL) and further processed. Typically, 20% of the amount of catalyst added can be effectively bound in this manner. This factor alone clearly confirms that the 3-phase reaction system based on statistically distributed structural elements in random order cannot be satisfactorily optimized.

In the following, this statement will be supported by a simple geometric estimate. As described above, the conversion of the fuel cell is directly dependent on the size of the inner active surface of the nanoporous reaction zone. Surface elements where the catalyst layer is embedded between the ion conductor and the electron conductor are referred to as active. To estimate the order of magnitude of this active surface, the idealized assumption is made that the graphite particles used in the active layer are arranged in a dense sphere packing. In this model, a 10 μm thick layer containing particles having a diameter of 50 nm would have an inner surface of 630 cm² (per 1 cm² base area). Now, exactly one third of the graphite particles are replaced by an ion-conducting material and a further third is replaced by a cavity. Moreover, the assumption is made that typically half the graphite surface is covered with Pt catalyst (which corresponds to common practice). The result is a maximum possible active surface of 35 cm². More refined calculations show that in real systems having statistically distributed structural elements, this value is much lower (which is easily understandable); one can assume an achievable active surface of about 10 cm².

The active surface is an important parameter. Also decisive for the performance of a fuel cell are the diverse loss mechanisms that are also mainly determined by the configuration of the active layer. Electrical losses occur because in a nanoporous structure, the numerous grain boundaries and constrictions inevitably result in increased resistance to ion and electron transport. However, the mass transfer in the nanoscale pores has a particularly crucial effect on the kinetics of the cell because each active surface element must be supplied with the reaction gas (oxygen on the cathode side, hydrogen on the anode side) and, moreover, water, the forming reaction product (at the cathode), must be removed. These diffusion processes, which are only driven by the concentration gradient, produce the greatest losses in the fuel cell systems known today (FIG. 2). Besides, further problematic effects, such as the so-called “catalyst flooding” (water accumulation), cold-start ability, and risk of icing are directly linked to the configuration of the MEA.

In U.S. Pat. No. 6,136,412, a nanostructure of needle-shaped elements is described as a carrier for the catalyst centers of a MEA configuration. The nanostructure is composed of an electrically nonconducting material. To maintain the required electric conductivity, the elements of the nanostructure must additionally be coated. The nanostructure is partially embedded in the polymer electrolyte membrane. To manufacture the MEA, first the nanostructure is made on an auxiliary substrate. Subsequently, the needle-shaped elements of the nanostructure are removed from the auxiliary substrate, for example by scraping or brushing off, and transferred to the surface of the membrane, especially by mechanically pressing them in. Because of this, an initially existing alignment of the needle-shaped elements is lost. Moreover, part of the needle-shaped elements will break off and be reduced to small pieces during the transfer process. This has been described as an advantage because in this manner, the surface is cleaved to a greater degree and therefore becomes larger.

It is an object of the present invention to provide a MEA configuration which, on the one hand, makes it possible to offer a sufficiently large inner reaction surface and which, on the other hand, allows a considerable reduction of the major loss factors of the fuel cell reactions, making it possible to exploit nearly the full performance potential of the fuel cell.

This objective is achieved by the subject matter of Patent Claim 1. Advantageous embodiments are the subject matter of dependent claims.

The basic concept of the present invention is to use an ordered regular micro- or nanostructured electrode structure instead of the disordered 3D reaction layer that is usually used today.

Specifically, there are two inventive variants of the electrode structure:

Electrically conductive, needle-shaped electrode elements (hereinafter also referred to as “nanowhiskers”) on a carrier substrate, and

electrically conductive, tube-shaped electrode elements (hereinafter also referred to as “nanotubes”) on a carrier substrate. These electrode elements can also be porous.

The electrode elements are coated with a catalyst, and completely or partially surrounded on the outside by the electrolyte material (for example, a polyelectrolyte membrane). The catalytic reaction zones at the electrode elements are connected to the gas transport system of the fuel cell via perforations in the carrier substrate. Alternatively, the carrier substrate can also be composed of a porous material, so that no additional perforations have to be made. The electrode elements are connected to each other and to the external connections of the individual cell (typically bipolar plates) in an electrically conductive manner.

The electrode elements are distributed over the carrier substrate in a substantially regular manner, and, in particular, can be aligned essentially parallel to each other. The electrode elements are oriented out of the plane of the carrier substrate. The angle between the plane of the carrier substrate and the electrode elements is greater than 20°, preferably greater than 40°, and more preferably greater than 60°, for example, 90°.

In the following, the present invention will be explained in greater detail by means of specific embodiments with reference to Figures, in which:

FIG. 1 is a schematic diagram of the elementary reaction zone of a fuel cell;

FIG. 2 shows a diagram relating to the efficiency and major loss factors of a fuel cell;

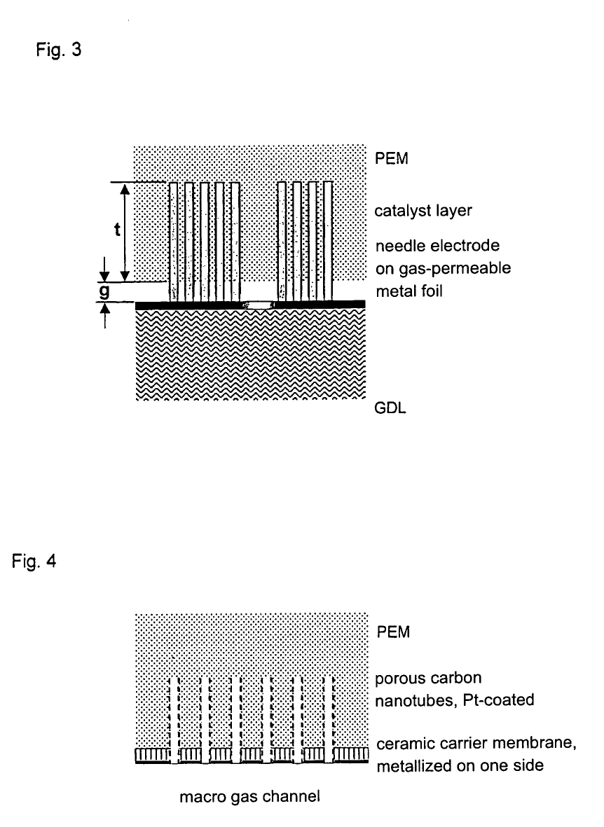

FIG. 3 is a schematic representation of a MEA configuration (nanowhiskers) according to the present invention;

FIG. 4 is a schematic representation of a further MEA configuration (nanotubes) according to the present invention;

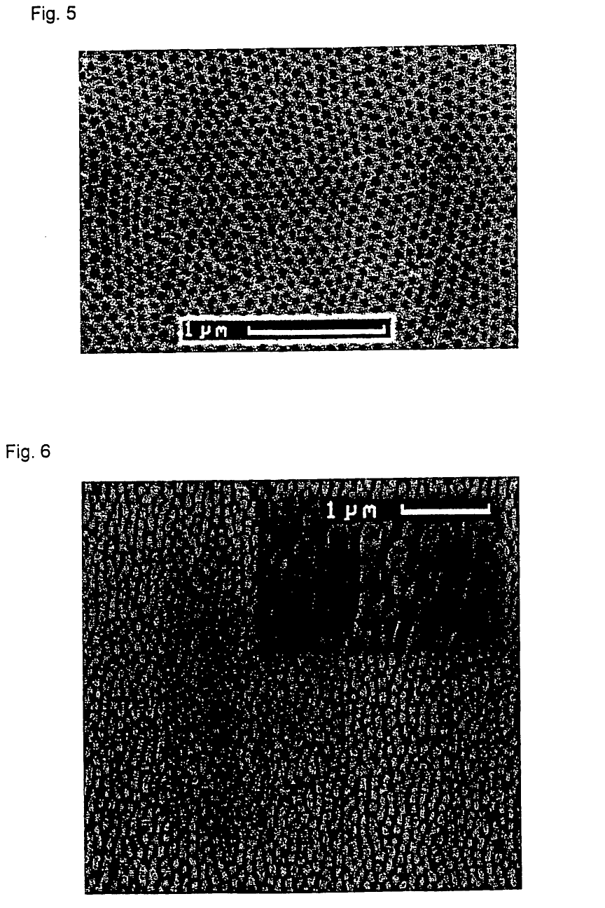

FIG. 5 shows a photograph of a nanoporous oxide matrix for making an electrode structure according to the present invention;

FIG. 6 shows a photograph of an electrode structure made of parallel-aligned nickel needles on a self-supporting nickel membrane

### SOLUTION VARIANT “NANOWHISKER”

FIG. 3 is a schematic representation of a first MEA configuration according to the present invention. There can be seen the needle-shaped, nanoscale electrode elements that are regularly arranged on a metal foil and, together therewith, form the electrode of the MEA. The needle-shaped electrode elements, which can, in particular, be composed of a metallic material, such as nickel, penetrate into the PEM almost completely or to a defined depth t, and are platinum-coated in this zone. The metallic carrier foil of the needles has gas-permeable openings through which the reaction gases reach a gas-distribution channel g between the metal foil and the PEM, and from there, they get directly to the catalytic reaction zones. Adjacent to the smooth side of the metal foil is the GDL, which neighbors the macro gas distribution channels of the bipolar plate (not drawn here).

Thus, the gas transport system (bipolar plate, GDL, and gas distribution channel) has a hierarchical design, similar to the bronchial system of a lung (windpipe, tracheae, alveoli), and can thereby function very effectively.

Exemplary Design:

The advantages of the electrode structure according to the present invention can be easily explained using the notion of a model used above. A typical reaction surface of about 10 cm² could be achieved, for example, with a parallel-aligned needle structure having the following dimensions:

| | |
|---|---|
| needle diameter | 10 nm |
| surface filling factor of the needles | 40% |
| ion conductor cross-section | 60% |
| depth of reaction zone t | 100 nm |
| platinum layer thickness | 1 nm |
| depth of gas channel g | 10 nm |
| gas passage openings | 10 μm at intervals of 100 μm |

This needle structure is comparable to prior art in terms of reaction surface and catalyst usage, but offers decisive advantages with regard to reaction kinetics. Gas diffusion is promoted by the relatively open needle structure, which is directly connected to the macroscopic GDLs via gas channel g. The gas molecules no longer have to move through a relatively deep, nanoporous structure. On the basis of estimates of this effect, an improvement by more than two orders of magnitude can be expected, that is, the gas diffusion would no longer be a limiting factor. Something similar applies to ionic conductivity; the whiskers are directly coupled to the highly-conductive PEM so that the active layer of the conventional type with its geometry-related compromises can be dispensed with, and depletion effects at the reaction zone are virtually negligible.

A further interesting aspect is to look at the heat dissipation. While the heat transport in the conventional system needs to overcome a nonwoven carbon fabric having a thickness of several 100 μm in order to reach the bipolar plate or the open gas flow, in the case of the needle electrode according to the present invention, this distance is only several 100 nm in metallic structures, that is, a negligible barrier.

Solution Variant “Nanotube”

A further inventive solution by which the principle of a hierarchical gas transport system is implemented even more consistently is schematically shown in FIG. 4. Porous, nanoscale tubes (for example, of graphite) that are coated on the outside with platinum are regularly arranged on a carrier membrane made, for example, of ceramics. In the embodiment shown, the carrier membrane is metallized on its smooth side so that the nanoscale tubes are electrically connected to each other. The tubes are completely surrounded on the outside by the ion-conducting layer. The carrier membrane features gas-permeable openings through which the reaction gases get directly from the macro gas channels of the bipolar plate into the interior of the tubes, and further through the porous wall of the tubes to the catalytic reaction zones.

It is obvious that a MEA configuration of this type has several important advantages:

controlled adjustment of all geometric parameters;

arbitrary reaction surface density according to the selected geometry;

full utilization of the noble-metal catalyst used;

conventional 3D reaction layer and GDL are dispensed with;

diffusion inhibition becomes vanishingly small both in the PEM and in the gas space;

short paths for water to diffuse out, i.e., risk of catalyst flooding is strongly reduced or completely eliminated;

hierarchical gas transport system with new degrees of design freedom;

possibility of producing the MEA as a self-supporting module, thus providing the prerequisite for the use of simplified, low-weight bipolar plates;

optimum cooling through short paths and metallic heat dissipation;

compact, low-weight stack design.

This description gives an idea of the potential improvement of individual influencing factors. This does not yet allow to draw any conclusions about potential increases in performance of the overall system, in which these factors are in a complex relationship. Nevertheless, it is possible to derive the following conclusions:

Given a nominally equal reaction surface density, i.e., conversion per electrode area, the MEA configurations according to the present invention offer considerable savings in the use of noble metals as well as improved heat dissipation.

The efficiency can be considered in a first approximation, independently of the conversion. In both systems (nanowhisker and nanotube), the major loss factors due to conduction and diffusion mechanisms can be reduced by more than one order of magnitude according to the above estimates. In conventional MEA systems, these losses are about 40% (FIG. 2).

Apart from the technical performance, the use of a defined regular electrode structure facilitates the computer-aided modeling and optimization of the MEA function to a very considerable degree, thereby offering significant additional advantages, especially by saving development time and costs; through improved quality controls and failure analyses; etc.

In each of the embodiments of the present invention described, a membrane was used as the ion-conducting electrolyte. It is pointed out that the present invention is not limited to this particular electrolyte type, but that, in principle, it is possible to use any ion-conducting layer or coating.

Manufacturing Method

To manufacture the structures according to the present invention, many process variants can be used, depending on the purpose of use. First, typically an oxide matrix having regularly arranged cylindrical pores is produced on the basis of a template method (FIG. 5), it being possible to reliably adjust the geometry parameters over a wide range. The dependence of the geometry parameters of pore diameter, pore spacing, and oxide layer thickness on the process parameters of anodizing voltage, current density, temperature, type and degree of acidity of the electrolyte are generally known from the classical anodization technique. Typical achievable values of the pore diameters and pore spacings are from about 10 nm to several 100 nm, of which especially the smaller dimensions below 100 nm appear to be interesting for MEA applications due to the mentioned reasons. The height of the structures is several 100 nm to 1000 or 2000 nm. Illustratively, an aspect ratio of a whisker structure of 1:10 corresponds to the above-mentioned area ratio of 10 cm² reaction surface over 1 cm² base area of an active layer according to the prior art.

Subsequently, particles for forming the needle- or tube-shaped electrode elements are embedded into the pores, it being possible to use different methods, depending on the material and type of construction. Suitable methods for depositing metallic particles of nickel, cobalt, chromium, manganese, copper, zinc, tin, and of noble metals are, in particular, electrochemical and electroless plating methods, while pyrolytic methods are used for depositing graphite-like layers or other metals. Examples here include the decomposition of acetylene or other hydrocarbons or of metal-organic compounds in the gas phase under the action of temperature, catalysts and/or plasma discharges. For example, the oxides structure can also be impregnated with a wetting solution of suitable monomers (acrylonitrile, emulsifier, initiator), and subsequently polymerized. The polymer (polyacrylonitrile) is pyrolized at elevated temperatures, and converted into graphite-like tubes or fibers. There are many known variants of this basic method that can, in principle, be used within the spirit of the present invention. However, the use of nanoscale electrode structures of graphite is regarded as particularly attractive because good electric conductivity, high chemical stability, and low cost of the starting materials can be made compatible in this manner.

Subsequently, the oxide matrix can be completely or partially removed.

In the described manner, it is possible, for example, for free-standing, parallel-aligned nickel needles having heights of several 100 μm to be anchored to a self-supporting nickel membrane (FIG. 6). It was also possible to produce aligned tubes of noble metals or carbon with high aspect ratios.

A particular challenge of the nanotube concept is to selectively adjust the porosity of the tube walls, which are made of, for example, graphite, in order to achieve the desired gas permeability. It has turned out that a special feature of the template method can be used to advantage for this purpose, using anodized oxide masks. In the case of anodic oxidation, pore formation does not occur in an exactly cylindrical manner, but with countless small lateral offsets, as can be seen by careful microscopic examination. The offsets are dependent on the anodization parameters and the starting material, and are typically a fraction below 50% of the pore diameter; however, a through-opening is maintained in almost all formed pores of a template. During the subsequent coating of the pore walls to form a tube-shaped structure, these offsets inevitably produce regular point defects and weak points at which increased gas permeation can take place as long as no excessive film thickness is adjusted. The quality of the starting material, i.e., the properties of the aluminum material, the crystal structure, grain structure, alloy constituents, impurities, etc., apparently influence the offset formation; however, the relationships have not been systematically clarified yet. It seems that the anodization conditions also influence the number and degree of the offsets; at least the offsets are promoted by small current densities and low bath temperatures; however, it is not possible to identify any systematic relationships here either.

Subsequently, this whisker- or tube-shaped electrode structure can be efficiently coated with the desired catalyst, for example, by electrodeposition or electroless deposition of noble metals. It is convenient for tube-shaped structures to be closed at their ends prior to this step, for example, using a special polymerization process during which the tips are slightly wetted with the monomer, and, if required, the gaps are washed out in the partially cross-linked state. Pointwise promotion of the polymerization at the tips can also be accomplished by applying catalytic polymerization starters, or by heating the structural elements. The tubes remain closed in the further course of production.

The integration of the MEA, i.e., the connection of the electrode structure and the electrolyte membrane, can be accomplished in different ways. In the simplest case, the nanostructured electrode film and the membrane are pressed together under defined conditions (pressure, temperature, degree of humidity, and time). The natural surface structure of the membrane prevents a gas-tight connection and allows gas access to a certain degree. If necessary, the gas channel can be enlarged by further measures prior to integration, for example, by microembossing of the PEM, by applying a highly porous spacer layer (that does not have to perform any electrical or chemical functions), or by applying a thin sacrificial layer, which is removed after the joining operation.

A further method for producing a regular electrode structure in an electrolyte membrane includes the following steps: Initially, metal whiskers are embedded in a porous, anodized aluminum foil as usual, and subsequently, the oxide layer is partially etched away so that the whiskers project above the surface to a certain height. This structure is coated with the catalyst, pressed into the electrolyte membrane, and subsequently, the aluminum carrier foil and the remaining Al oxide are chemically removed. After that, the free ends of the whiskers are connected to a gas-permeable, porous electrically conductive layer, for example, by applying (spreading, slurrying, or vapor-depositing) a two-component mixture, one component of which is subsequently removed through thermal or chemical treatment.

The nanotube structure does not require a gas channel between the PEM and the carrier foil, i.e., the electrode can be pressed into the membrane to its full depth. This process can be promoted by swelling the membrane and through the action of temperature, making it possible to process even mechanically sensitive structures. In an alternative embodiment, the gaps of the electrode elements are initially filled with a monomer, polymerized to form an ion-conducting polymer, and only then connected to the PEM film or another electrolyte.

What is claimed is:

1. A fuel cell composed of one or more individual cells; an individual cell including an electrolyte-electrode assembly, means for gas distribution of the reactants to the electrodes, as well as an electrical contacting of the individual cell, wherein
the electrodes include electrically conductive, regularly arranged micro- or nanoscale needle- or tube-shaped electrode elements that are anchored to a gas-permeable carrier substrate and coated with catalyst; and
the needle- or tube-shaped electrode elements are completely or partially surrounded on the outside by the electrolyte material; and
the catalytic reaction zones at the electrode elements are connected to the gas distribution means via the gas-permeable carrier substrate; and
the electrode elements are connected to each other and to the electrical contacting of the individual cell in an electrically conductive manner.

2. The fuel cell as recited in claim 1,
wherein the electrolyte is a membrane, in particular, a polymer electrolyte membrane.

3. The fuel cell as recited in claim 1 or 2,
wherein the tube-shaped electrode elements are composed of electrically conductive carbon.

4. The fuel cell as recited in one of the preceding claims,
wherein the electrode elements are composed of a metal.

5. The fuel cell as recited in one of the preceding claims,
wherein the carrier substrate is composed of a metal.

6. The fuel cell as recited in one of the preceding claims,
wherein the carrier substrate is composed of an oxide- or ceramic layer and coated with a metal.

7. The fuel cell as recited in one of the preceding claims,
wherein a macroscopic structure for distributing the reaction gases is immediately adjacent to the carrier substrate with the tube-shaped electrode elements anchored thereto.

8. The fuel cell as recited in one of the preceding claims,
wherein the electrode elements have an aspect ratio of about 10 or higher.

9. The fuel cell as recited in one of the preceding claims,
wherein the electrode elements have a diameter of less than 500 nm, preferably less than 200 nm.

10. The fuel cell as recited in one of the preceding claims,
wherein the gas-permeable carrier substrate is composed of a porous material and is provided with perforations.

11. The fuel cell as recited in one of the preceding claims,
wherein the catalytic centers are arranged on the electrode elements in such a manner that more than half of them are in direct contact with the electrolyte and with the electrode elements, and are at a distance of 100 nm from the gas distribution system.
